(19) United States
(12) Patent Application Publication
(10) Pub. No.: US 2006/0089981 A1
(43) Pub. Date: Apr. 27, 2006

(54) Supporting device information of a combo device in a universal plug and play network

(75) Inventors: Sung Joon Ahn, Yongin-si (KR); Chang Hyun Kim, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/255,741

(22) Filed: Oct. 21, 2005

Related U.S. Application Data
(60) Provisional application No. 60/620,675, filed on Oct. 22, 2004.

(51) Int. Cl. G06F 15/177

(52) U.S. Cl. 709/221

(57) ABSTRACT

The present invention relates to a method for bookmarking content being transferred between devices in a universal plug and play (UPnP) network. The method comprises receiving a request from a user for bookmarking content being transferred to at least one of a plurality of devices capable of performing playback of the content on which the bookmarking is requested, obtaining state information form the at least one of a plurality of devices, and creating a bookmark comprising the state information and source information of the state information. Preferably, the source information of the state information obtained from a first device of the plurality of devices is persistent information and not exposed to the network. Moreover, the source in formation of the state information obtained from the first device has the same structure as source information assigned to a second device of the plurality of devices.

### CROSS-REFERENCE TO RELATED APPLICATIONS

Pursuant to 35 U.S.C. § 119, this application claims the benefit of earlier filing date and right of priority to U.S. Provisional Application No. 60/620,675, filed on Oct. 22, 2004, the contents of which are hereby incorporated by reference herein in their entirety.

### FIELD OF THE INVENTION

The present invention relates to a method for providing and using general device information or service information provided by a combo device in a universal plug and play (UPnP) home network, and more particularly, to bookmarking content being transferred between devices in the UPnP network.

### BACKGROUND OF THE INVENTION

Networking technologies based on various types of small-sized devices have recently emerged and been commercialized. A home network enables the interconnection of various consumer electronics devices such as a refrigerator, television (TV) set, washing machine, personal computer (PC) and stereo, thus providing a convenient, user-friendly living environment.

A Universal Plug and Play (UPnP) standard has been proposed to provide a digital home network platform. Plug and Play (PnP) technology that is widely embodied in most PC operating systems simplifies the process of adding hardware to a device. UPnP technology is designed to extend the PnP technology to a network domain having platforms comprised of Internet standard technologies such as Transmission Control Protocol/Internet Protocol (TCP/IP), Hypertext Transfer Protocol (HTTP) and Extensible Markup Language (XML). Due to UPnP technology, various consumer electronics devices with network functions, network printers, and Internet Gates may be interconnected to each other to provide a unified network in which a new network device can readily be added and remotely accessed from other devices.

A UPnP network preferably comprises a plurality of UPnP devices, services and a control point (CP). Each service that is the least accessible, controllable unit in the UPnP network is designated by its own unique state variables. The CP is a control application that runs on a device in the network, such as a personal digital assistant (PDA), and is capable of accessing, monitoring, and controlling all of the devices on the network and/or their services.

As shown in FIG. 1, a Universal Plug and Play Audio-Visual (UPnP AV) home network comprises a media server 120 for providing audio-visual (AV) data to devices on the network, a media renderer 130 for performing playback of the AV data and a control point (CP) 110 for controlling the media server 120 and the media renderer 130. Both the media server 120 and the media renderer 130 are controlled by the CP 110, hence, they are called controlled devices.

Playback of the media data in the network of FIG. 1 is described below. The media server 120 obtains information about media data files, such as directory path information, for example, through its own file system and sends this information to the CP 110 in response to a UPnP action, such as a browsing action. Once a media file stored in the media server 120 is chosen via a user interface (UI) on the CP 110, a stream of the media data file is sent to and presented at the media renderer 130.

Notably, UPnP enabled devices such as the media server 120 and the media renderer 130 may be embedded in a single device together with the control point 1 10. In such a case, the UPnP devices configured together with the control point 110 cannot be discovered as UPnP devices on the home network. Therefore, neither their device descriptions nor UPnP actions on their services can be provided to and requested from another UPnP device on the home network.

Generally, the UPnP device described above is called a combo device. FIG. 2A illustrates an AV network configuration, wherein a combo device 201 comprising a control point and a media renderer communicates with a media server. FIG. 2B illustrates another AV configuration, wherein a combo device 202 comprising a control point and media server communicates with a media renderer.

Action requests within the combo devices, specifically, action requests between the control point and the media renderer in FIG. 2A, and action requests between the control point and the media server in FIG. 2B, do not need to be in accordance with UPnP protocols because they are not invisible to other devices on the home network. Hence, data communication within a combo device is usually made through an arbitrary internal interface.

It is, however, often desirable to enable UPnP devices on the network to access state information on services provided by a controlled device within the combo device. For example, if a request is made from a user to bookmark a content being streamed by a media server and being presented by a media renderer within a combo device, then a control point within the combo device obtains state information required to make a bookmark from the media renderer internally. If necessary, the control point stores the obtained state information as a bookmark constituting information in an external media server together with other information.

However, the bookmark created in this way cannot be interpreted appropriately from a control point other than the control point within the combo device even if the bookmark has been obtained from the media server. This is because the state information obtained internally from the combo device is organized arbitrarily such that its format is not in accordance with the UPnP protocol.

### SUMMARY OF THE INVENTION

The present invention relates to a method for bookmarking content being transferred between devices in a universal plug and play (UPnP) network. In view of the shortcomings of the prior art, it is an object of the present invention to provide a method of organizing and using state information about a controlled device within a combo device in such a way that devices connected to the same network use the state information accordingly.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the present invention is embodied in a method for bookmarking content being transferred between devices in a network, the method comprising receiving a request for bookmarking content being transferred to at least one of a plurality of devices capable of performing playback of the content on which the bookmarking is requested, obtaining state information from the at least one of a plurality of devices, and creating a bookmark comprising the state information and source information of the state information, wherein the source information of the state information obtained from a first device of the plurality of devices is persistent information and not exposed to the network, wherein the source information of the state information obtained from the first device has the same structure as source information assigned to a second device of the plurality of devices other than the first device.

The source information comprises a unique device identifier (UDN), a service ID, and a service type. Preferably, the source information is internally obtained.

In one aspect of the invention, the first device is a media renderer for rendering the content provided by the second device. Preferably, the step of obtaining state information from the at least one of a plurality of devices comprises obtaining state information for playback management from the second device and obtaining state information for rendering control internally from the media renderer. Preferably, the steps of obtaining state information for playback management from the second device and obtaining state information for rendering control internally from the media render comprise invoking an action for obtaining state variables.

In another aspect of the invention, the source information of the state information obtained from the second device is obtained from a device and service descriptor provided from the second device when the second device is initially discovered on the network.

Preferably, the step of creating the bookmark comprises creating the bookmark in the second device by invoking an object creating action to the second device.

In a further aspect of the invention, the first device is a media server for providing content to the second device. Preferably, the step of obtaining state information from the at least one of a plurality of devices comprises obtaining state information for internal playback management from the media server and obtaining state information for rendering control from the second device. Preferably, the steps of obtaining state information for internal playback management from the media server and obtaining state information for rendering control from the second device comprise invoking an action for obtaining state variables.

In another aspect of the invention, the source information of the state information obtained from the second device is obtained from a device and service descriptor provided from the second device when the second device is initially discovered on the network.

Preferably, the step of creating the bookmark comprises creating the bookmark internally in the media server.

In accordance with another embodiment of the present invention, a method for bookmarking content being transferred between devices in a network comprises utilizing a transport service and a control service for transferring the content, receiving a request for bookmarking the content being transferred, obtaining state information of the transport service and the control service, wherein the state information of at least one of the transport service and the control service is obtained through an internal interface that is not subject to a communication protocol on the network, and creating a bookmark comprising the state information and source information of the state information.

Preferably, the transport service is an AVTransport service (AVTS) and the control service is a Rendering Control Service (RCS). Moreover, the source information of the state information obtained through the internal interface is persistent information and not exposed to the network, and has the same structure as source information assigned to a device exposed to the network.

In one aspect of the invention, the transport service, the control service and a control application for controlling the transport service and the control service are integrated in a combo device. In another aspect of the invention, the control service and the control application for controlling the transport service and the control service are integrated in a combo device. In a further aspect of the invention, the transport service and the control application for controlling the transport service and the control service are integrated in a combo device.

Preferably, the source information comprises a unique device identifier (UDN), a service ID, and a service type.

In accordance with another embodiment of the present invention, an apparatus for bookmarking content being transferred between devices in a network comprises means for receiving a request for bookmarking content being transferred to at least one of a plurality of devices capable of performing playback of the content on which the bookmarking is requested, means for obtaining state information from the at least one of a plurality of devices, and means for creating a bookmark comprising the state information and source information of the state information, wherein the source information of the state information obtained from a first device of the plurality of devices is persistent information and not exposed to the network, wherein the source information of the state information obtained from the first device has the same structure as source information assigned to a second device of the plurality of devices other than the first device.

The source information comprises a unique device identifier (UDN), a service ID, and a service type. Preferably, the source information is internally obtained.

In one aspect of the invention, the first device is a media renderer for rendering the content provided by the second device. Preferably, the means for obtaining state information from the at least one of a plurality of devices comprises means for obtaining state information for playback management from the second device and means for obtaining state information for rendering control internally from the media renderer. Preferably, the means for obtaining state information for playback management from the second device and obtaining state information for rendering control internally from the media render comprise invoking an action for obtaining state variables.

In another aspect of the invention, the source information of the state information obtained from the second device is obtained from a device and service descriptor provided from the second device when the second device is initially discovered on the network.

Preferably, the means for creating the bookmark comprises means for creating the bookmark in the second device by invoking an object creating action to the second device.

In a further aspect of the invention, the first device is a media server for providing content to the second device. Preferably, the means for obtaining state information from the at least one of a plurality of devices comprises means for obtaining state information for internal playback management from the media server and means for obtaining state information for rendering control from the second device. Preferably, the means for obtaining state information for internal playback management from the media server and obtaining state information for rendering control from the second device comprise invoking an action for obtaining state variables.

In another aspect of the invention, the source information of the state information obtained from the second device is obtained from a device and service descriptor provided from the second device when the second device is initially discovered on the network.

Preferably, the means for creating the bookmark comprises creating the bookmark internally in the media server.

In accordance with another embodiment of the present invention, an apparatus for bookmarking content being transferred between devices in a network comprises means for utilizing a transport service and a control service for transferring the content, means for receiving a request for bookmarking the content being transferred, means for obtaining state information of the transport service and the control service, wherein the state information of at least one of the transport service and the control service is obtained through an internal interface that is not subject to a communication protocol on the network, and means for creating a bookmark comprising the state information and source information of the state information.

Preferably, the transport service is an AVTransport service (AVTS) and the control service is a Rendering Control Service (RCS). Moreover, the source information of the state information obtained through the internal interface is persistent information and not exposed to the network, and has the same structure as source information assigned to a device exposed to the network.

In one aspect of the invention, the transport service, the control service and a control application for controlling the transport service and the control service are integrated in a combo device. In another aspect of the invention, the control service and the control application for controlling the transport service and the control service are integrated in a combo device. In a further aspect of the invention, the transport service and the control application for controlling the transport service and the control service are integrated in a combo device.

Preferably, the source information comprises a unique device identifier (UDN), a service ID, and a service type.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIG. 1 illustrates a general UPnP AV network configuration.

FIG. 2A illustrates a UPnP AV network configuration having a combo device, wherein a control point and a media renderer embedded in the combo device are connected to a media server.

FIG. 2B illustrates a UPnP AV network configuration having a combo device, wherein a control point and a media server embedded in the combo device are connected to a media renderer.

FIG. 3 illustrates a method for creating and using a bookmark, wherein a media renderer and a control point are integrated in a combo device and contents are streamed in a pull mode in accordance with one embodiment of the present invention.

FIG. 4 illustrates a structure of a bookmarked object in accordance with one embodiment of the present invention.

FIG. 5 illustrates a method for creating and using a bookmark, wherein a media renderer and a control point are integrated in a combo device and contents are streamed in a push mode in accordance with one embodiment of the present invention.

FIG. 6 illustrates a method for creating and using a bookmark, wherein a media server and a control point are integrated in a combo device and contents are streamed in a pull mode in accordance with one embodiment of the present invention.

FIG. 7 illustrates a method for creating and using a bookmark, wherein a media server and a control point are integrated in a combo device and contents are streamed in a push mode in accordance with one embodiment of the present invention.

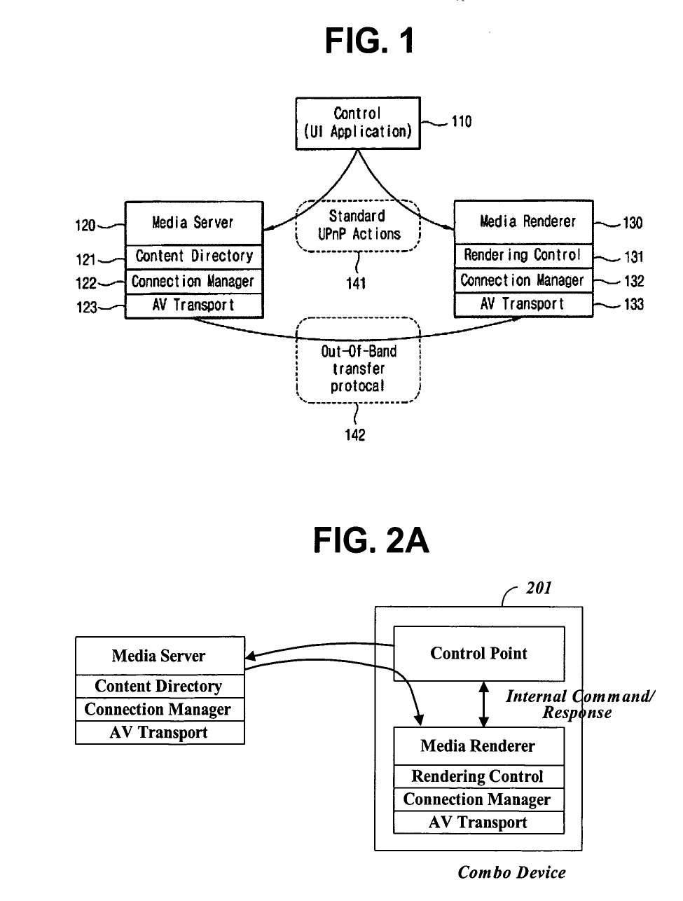

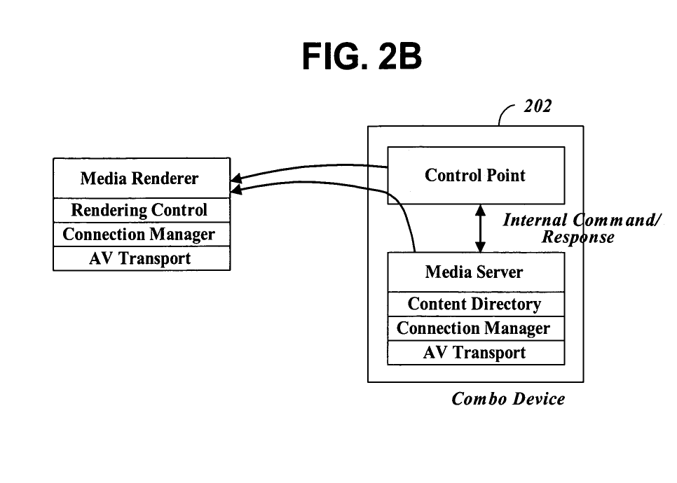

### DETAILED DESCRIPTION OF THE PREFERRED EMBODIMENTS

The present invention relates to a method for bookmarking content being transferred between devices in a universal plug and play (UPnP) network.

In order that the invention may be fully understood, preferred embodiments thereof will now be described with reference to the accompanying drawings. Hereinafter, embodiments of the present invention are explained such that state information within a combo device, which external devices request to use, is preferably bookmark information. However, the present invention is applicable to all state information that a combo device provides to external devices.

In accordance with the present invention, at least four different configuration cases exist for creating the bookmark information. Two configuration cases depend on a content streaming type, i.e., push mode and pull mode. The other two configuration cases depend on whether the combo device includes a media renderer or a media server. The procedure for preparing the state information in the combo device for use in external devices in response to a bookmark request is described below for each configuration case.

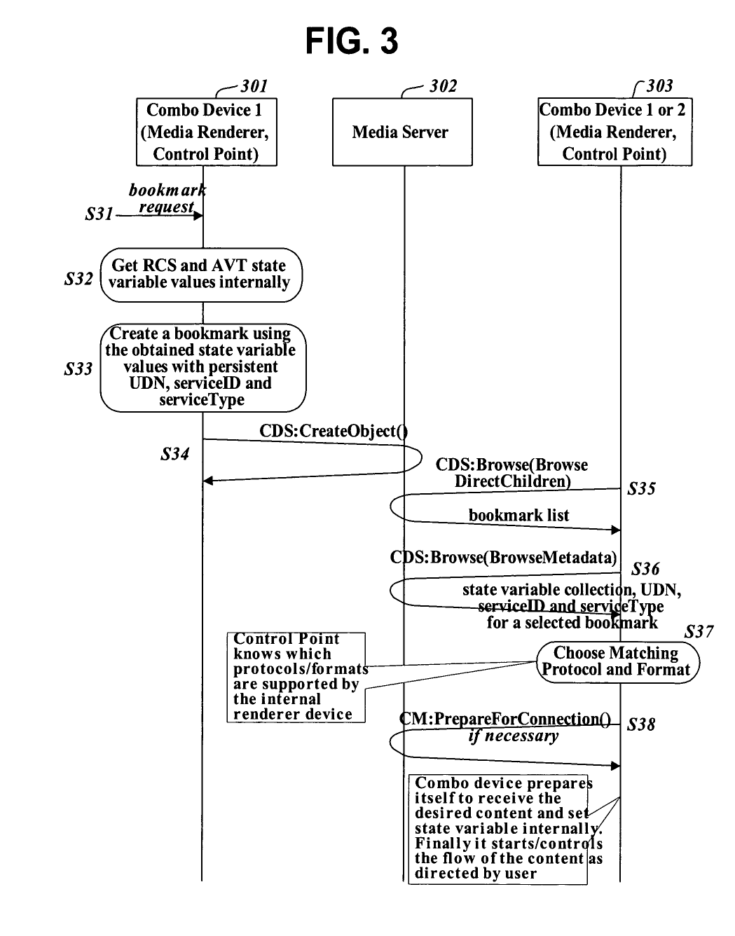

FIG. 3 illustrates a method for creating and using a bookmark, wherein a media renderer and a control point are integrated in a combo device and contents are streamed in a pull mode.

Referring to FIG. 3, in a state where AV data is streamed from a media server 302 to a combo device 301 containing a media renderer, if a bookmark request is made by a user (S31), a control point within the combo device 301 obtains state variables allocated for content being streamed using a Rendering Control Service (RCS) and an AVTransport Service (AVTS) (S32). In the pull mode, the AVTS is provided by the media renderer. Therefore, AVT state variables are obtained from the media renderer within the combo device 301 through an internal communication protocol. RCS state variables are obtained in the same manner as the AVT state variables.

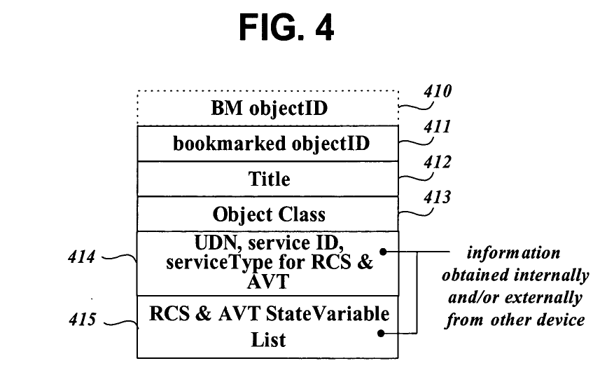

Using the received RCS state variables and AVT state variables, the control point collects information needed to create a bookmarked object, as shown in FIG. 4. Persistent device information, preferably, a Unique Device Name (UDN) (device identifier), a service ID, and a service type (414), which are hard-coded in the AVTS and RCS of the media renderer, are added to the bookmarked object as source information of the acquired RCS and AVT state information (415) (S33 of FIG. 3). The persistent device information is not exposed to external devices through action requests such as a discovery action and is maintained unless the device or the service in the device is upgraded.

An identifier of the content being bookmarked (ID of object content being streamed) (411), legible content information such as a string-formatted bookmark title (412), and a bookmark object class (413) defined in a form such as “object.item.bookmarkitem”, for example, are generated as additional information required for the bookmarked object of FIG. 4. After, the control point invokes an object creation action (CreateObject()) in a Content Directory Service (CDS) of the media server 302 by using the collected information as CDS input variables (S34). Receiving the information from the control point, the CDS creates a bookmarked object and assigns a bookmarked object identifier 410 to the created bookmarked object, as shown in FIG. 4.

As shown in FIG. 3, after bookmark creation is completed and playback of the content is finished, an arbitrary device 303 sends an object browsing action request to the media server 302 to access a particular bookmark (S35). By choosing an object among the browsed objects, for example, an object previously bookmarked, and requesting an action to browse metadata of the previously bookmarked object (S36), all information on the bookmarked object is obtained.

However, the arbitrary device 303 may be the combo device 301 comprising a media renderer or another combo device on which a control point in running. If playback of the bookmarked object is requested by a user on the arbitrary device 303, the arbitrary device 303 determines, based on information included in the bookmarked object, whether or not the protocol and format of the bookmarked object is supported by the media renderer in the device 303. The arbitrary device 303 further determines whether or not the state variable values included in the information of the bookmarked object are acceptable by the media renderer in the device 303 (S37).

Whether or not the state variable values included in the information of the bookmarked object are acceptable by the internal media renderer is confirmed by comparing information of the bookmarked object, such as the UDN, service ID and service type, to corresponding information hard-coded in the internal media renderer. For example, if the UDNs are the same, such as where the device 303 is the combo device 301, and if a version of the service type of the bookmarked object is lower or the same as that of the internal media renderer, then it is determined that the bookmarked object can be played back on the device 303.

If the UDNs are different or the version of the service type of the bookmarked object is higher, the RCS state variable values included in the information of the bookmarked object are discarded. Default values are then set in the RCS state variables of the internal media renderer. Likewise, for the AVT state variables, acceptable values of AVT state variable values included in the information of the bookmarked object are set in the AVT service of the internal media renderer so that the bookmarked object is played back accordingly.

When it is determined that playback of the bookmarked object is possible, the control point of the device 303 requests an action for establishing a connection with the media server 302 as needed (S38). The control point of the device 303 then sets AVT and RCS state variables of the internal media renderer based on state variable values of the bookmarked object. The control point of the device 303 also requests the internal media renderer to prepare for receiving a stream of the bookmarked object and performs control executions to play back the bookmarked object from a desired point of the object as requested.

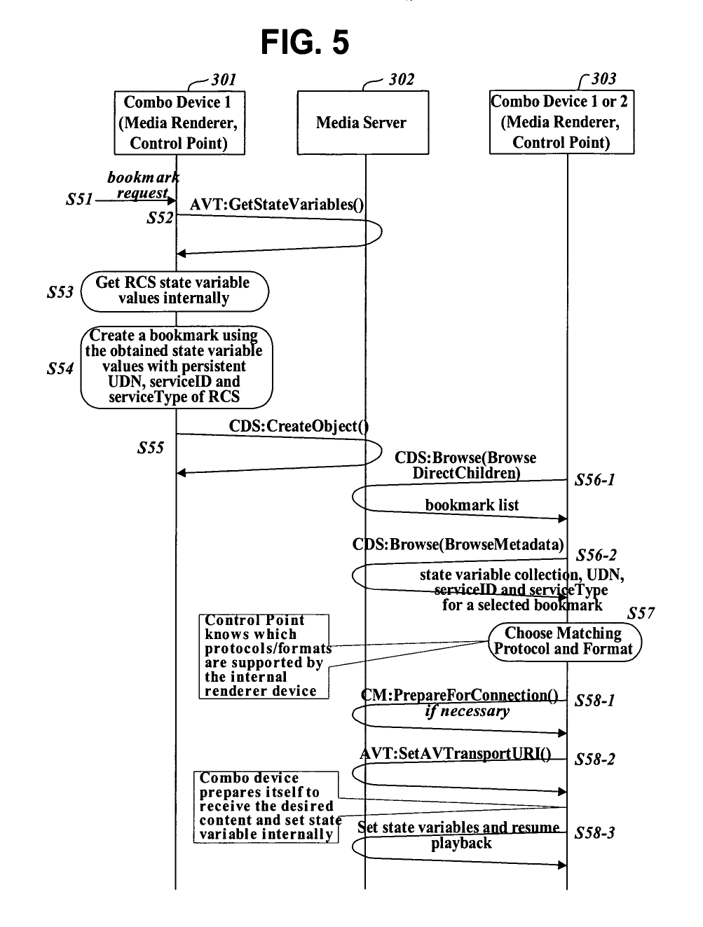

FIG. 5 illustrates a method for creating and using a bookmark, wherein a media renderer and a control point are integrated in a combo device and contents are streamed in a push mode.

Referring to FIG. 5, in the state where AV data is streamed from a media server 302 to a combo device 301 containing a media renderer, if a bookmark request is made by a user (S51), the control point within the combo device 301 obtains state variables allocated for content being streamed using a Rendering Control Service (RCS) and an AVTransport Service (AVTS) (S52, S53). In the push mode, AVTS is provided by the media server 302. Therefore, AVT state variables are obtained using an action in the AVTS of the media server 302 (S52). RCS state variables are obtained from the internal media renderer through an internal communication protocol (S53).

Using the received RCS state variables and AVT state variables, the control point collects information required to create a bookmarked object as shown in FIG. 4. Persistent device information, such as a UDN, service ID and service type, which are hard-coded in the RCS of the media renderer are added to the bookmarked object as source information of the acquired RCS state information. For the AVTS state variables, the UDN, service ID, and service type, which have been initially obtained in a device discovery step, are used as source information of the acquired AVTS state information (S54). Additional information required to create a bookmarked object is generated and added in the same manner as in the method of FIG. 3.

Subsequently, the control point in the combo device 301 invokes an object creation action (CreateObject()) in a Content Directory Service (CDS) of the media server 302 using the collected information as CDS input variables (S55). Receiving the information from the control point, the CDS creates a bookmarked object and assigns a bookmarked object identifier 410 (as shown in FIG. 4) to the created bookmarked object. Thus, a bookmarked object, as that of FIG. 4, is created in the media server 302.

As shown in FIG. 5, after bookmark creation is completed and playback of the content is finished, an arbitrary device 303 sends an object browsing action request to the media server 302 to access a particular bookmark (S56-1). By choosing an object among the browsed objects, for example, an object previously bookmarked, and requesting an action to browse metadata of the previously bookmarked object (S56-2), all information on the bookmarked object is obtained.

However, the arbitrary device 303 may be the combo device 301 comprising a media renderer or another combo device on which a control point in running. If playback of the bookmarked object is requested by a user on the arbitrary device 303, the arbitrary device 303 determines whether or not the protocol and format of the bookmarked object is supported by the media renderer in the device 303. The arbitrary device 303 further determines whether or not the state variables included in the information of the bookmarked object are acceptable by the media renderer in the device 303 (S57).

Whether or not the state variable values included in the information of the bookmarked object are acceptable by the internal media render is confirmed by comparing information of the bookmarked object, such as the UDN, service ID and service type, to corresponding information hard-coded in the internal media render. For example, if the UDNs are the same, such as where the device 303 is the combo device 301, and if a version of the service type of the bookmarked object is lower or the same as that of the internal media renderer, then it is determined that the bookmarked object can be played back on the device 303.

If the UDNs are different or the version of the service type of the bookmarked object is higher, the RCS state variable values included in the information of the bookmarked object are discarded. Default values are then set in the RCS state variables of the internal media renderer. The AVT state variables in the media server 302 are set by sending a request to the media server 302 so that the bookmarked object is played back accordingly.

When it is determined that playback of the bookmarked object is possible, the control point of the device 303 requests an action for establishing a connection with the media server 303 as needed (S58-1). The control point of the device 303 then sets RCS state variables of the internal media renderer based on the RCS state variables of the bookmarked object and sends information regarding the content being played back to the media server 302 using a SetAVTransportURI() action in the AVTS of the media server 302 (S58-2). The control point of the device 303 also requests the internal media renderer to prepare for receiving a stream of the bookmarked object, sets the AVT state variables of the bookmarked object in the AVTS of the media server 302, and performs control executions to play back the bookmarked object from a desired point of the object as requested (S58-3).

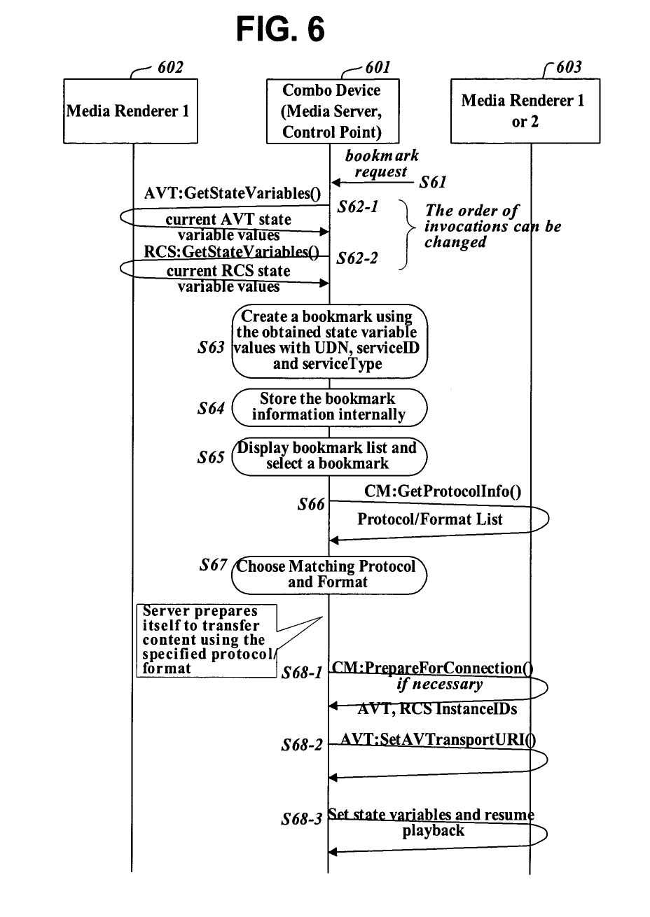

FIG. 6 illustrates a method for creating and using a bookmark, wherein a media server and a control point are integrated in a combo device and contents are streamed in a pull mode.

Referring to FIG. 6, in the state where AV data is being streamed from a media server within a combo device 601 to a media renderer 602, if a bookmark request is made by a user (S61), the control point within the combo device 601 obtains state variables allocated for content being streamed using a RCS (Rendering Control Service) and AVTS (AVTransport Service) (S62-1, S62-2). In the pull mode, AVTS is provided by the media renderer. Therefore, AVT state variables and RCS state variables are obtained from a media renderer 602 using a GetStateVariables() action. The order in which the AVT and RCS state variables are obtained is arbitrary.

Using the received RCS state variables and AVT state variables, the control point within the combo device 601 collects information needed to create a bookmarked object, as shown in FIG. 4. Information such as a UDN, service ID, and service type of the RCS and AVTS of the media renderer 602, which have been obtained from a device and service descriptor and identified through an initial device discovery step, are added as source information of the RCS and AVT state information (S63). Additional information required to create a bookmarked object is generated and added in the same manner as in the method of FIG. 3.

After generating information needed to create the bookmarked object, the control point in the combo device 601 creates the bookmarked object, assigns an identifier to the created bookmarked object and stores the bookmarked object internally (S64). Accordingly, the format in which the bookmarked object is stored does not necessarily agree with the format of the bookmarked object of FIG. 4 as long as the information shown in FIG. 4 is included.

After bookmark creation is completed and playback of the content is finished, a user requests the combo device 601 to provide all bookmarked objects to access a particular bookmark. By choosing an object among the browsed objects, for example, an object previously bookmarked and requesting an action to browse metadata of the previously bookmarked object, all information on the bookmarked object is obtained (S65).

In response to a playback request of the chosen object, the control point in the combo device 601 invokes a GetProtocoInfo() action in an arbitrary media renderer 603 to obtain a list of protocols and formats supported by the media renderer 603 (S66). From the protocol and format list, the control point in the combo device 601 determines if the media renderer 603 supports the protocol and format of the bookmarked object.

However, the arbitrary media renderer 603 may be the media renderer 602. If it is determined that the bookmarked object is supported, the control point in the combo device 601 chooses an appropriate protocol and format (S67) and requests the internal media server to prepare for sending the bookmarked object in accordance with the chosen protocol and format.

The control point in the combo device 601 then sends a request to the media renderer 603 to prepare a connection with the combo device 601 as needed (S68-1). In response to the request, the arbitrary renderer 603 transmits to the combo device 601 an instant ID that the AVTS and RCS assign to the established connection. The instant ID is used to specify and control the RCS and ATVS during streaming of the bookmarked object.

The control point in the combo device 601 sends information on content being played back to the media renderer 603 using an SetAVTransportURI() action in the AVTS of the media renderer 603 (S68-2). The control point in the combo device 601 also requests the RCS and AVTS of the media renderer 603 to use the RCS and AVTS state variable values that are included in the bookmarked object. The control point further performs control executions to play back the bookmarked object from a desired point of the object as requested (S68-3).

In response to the request of setting the AVTS and RCS state variables, if the media renderer 603 is the same as the media renderer 602 playing the content being requested to bookmark, the AVTS and RCS state variable values are used unmodified in the AVTS and RCS. Otherwise, the RCS state variable values are discarded and default values are used in the RCS. For the AVTS state variables, preferably adoptable values, such as the point in the content where playback has been stopped, are used in the AVTS.

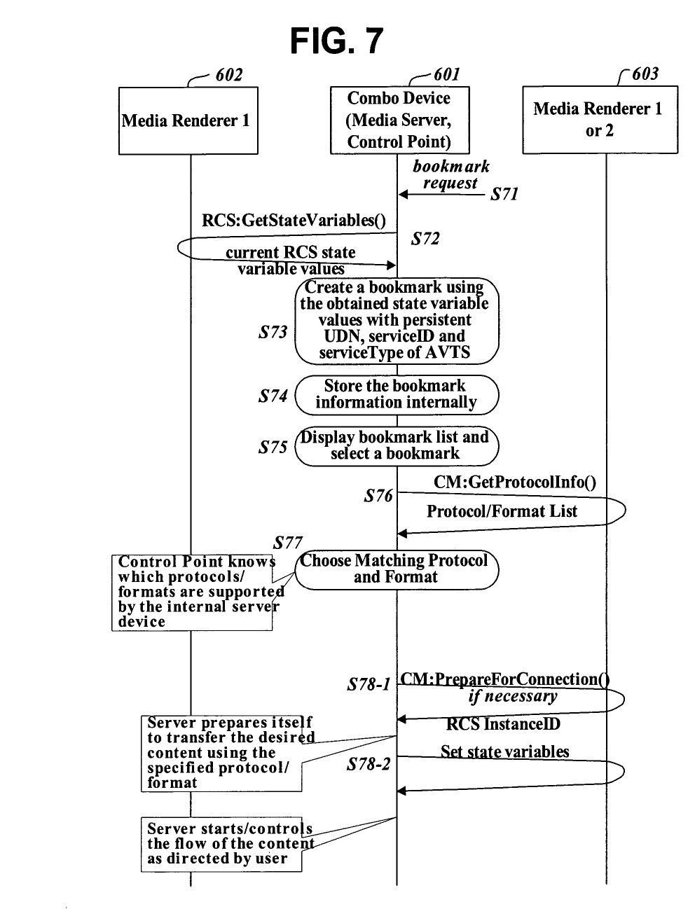

FIG. 7 illustrates a method for creating and using a bookmark, wherein a media server and a control point are integrated in a combo device and contents are streamed in a push mode.

Referring to FIG. 7, in the state where AV data is being streamed from a media server within the combo device 601 to a media renderer 602, if a bookmark request is made by a user (S71), the control point within the combo device 601 obtains RCS state variables allocated for content being streamed using a RCS (Rendering Control Service) in the media renderer 602 (S72). In the push mode, AVTS is provided by the media server within the combo device 601. Therefore, AVT state variables are obtained through an internal interface.

Using the received RCS state variables and AVT state variables, the control point within the combo device 601 collects information needed to create a bookmarked object, as shown in FIG. 4. Information such as a UDN, service ID, and service type of the RCS of the media renderer 602, which have been obtained from a device and service descriptor and identified during an initial device discovery step, are added as source information of the RCS state information. A hard-coded UDN, service ID, and service type, which have been obtained through the internal interface, are used for source information of the AVTS state information (S73). Additional information required to create a bookmarked object is generated and added in the same manner as in the method of FIG. 3.

After generating information needed to create the bookmarked object, the control point in the combo device 601 creates the bookmarked object, assigns an identifier to the created bookmarked object and stores the bookmarked object internally (S74). Accordingly, the format in which the bookmarked object is stored does not necessarily agree with the format of the bookmarked object of FIG. 4 as long as the information shown in FIG. 4 is included.

After bookmark creation is completed and playback of the content is finished, a user requests the combo device 601 to provide all bookmarked objects to access a particular bookmark. By choosing an object among the browsed objects, for example, an object previously bookmarked, and requesting an action to browse metadata of the previously bookmarked object, all information on the bookmarked object are obtained (S75).

In response to a playback request of the chosen object, the control point in the combo device 601 invokes a GetProtocoInfo() action in an arbitrary media renderer 603 to obtain a list of protocols and formats supported by the media renderer 603 (S76). From the protocol and format list, the control point in the combo device 601 determines if the media renderer 603 supports the protocol and format of the bookmarked object.

However, the arbitrary media renderer 603 may be the media renderer 602. If it is determined that the bookmarked object is admissible, the control point in the combo device 601 chooses an appropriate protocol and format (S77) and then determines if the AVTS state variable values in the bookmarked object information are admissible by comparing information such as a UDN, service ID, and service type to corresponding information hard-coded in an internal media server. For example, if the UDNs are the same and a version of the service type of the bookmarked object is lower or the same as that of the internal media server, then the bookmarked object is determined to be an admissible object. Thus, the AVTS state variable values are accepted and set unmodified. But, if the version of the service type of the bookmarked object is higher than that of the internal media server, then some admissible AVTS state variable values are used and others are discarded.

The control point in the combo device 601 then sends a request to the internal media server to prepare sending the bookmarked object in accordance with the chosen protocol and format. The control point also sends a request to the media renderer 603 to prepare a connection with the combo device 601 if necessary (S78-1). In response to the request, the arbitrary renderer 603 transmits to the combo device 601 an instant ID that the RCS assigns to the established connection. The instant ID is used to specify and control the RCS during streaming of the bookmarked object.

The control point in the combo device 601 then requests the RCS of the media renderer 603 to set the RCS state variable values of the bookmarked object (S78-2). The control point also sends information regarding the content being played back to the internal media server in order to stream the content from a desired point as requested by a user.

In response to the request to set the RCS state variables, if the media renderer 603 is the same as the media renderer 602 playing the content being requested to bookmark, the RCS state variable values are used unmodified in the RCS. Otherwise, the RCS state variable values are discarded and default values are used.

The present invention makes it possible for external devices to use information, e.g., bookmark information created for a non-discoverable device embedded in a combo device without any modification. Therefore, the present invention offers the same mechanism for applying state information that the bookmark contains when services in other devices are invoked. Hence, development becomes easier because service developers do not need to consider whether or not the device on which the service is installed is a combo device. For the same reasons, development of user interfaces also becomes simpler.

While the invention has been disclosed with respect to a limited number of embodiments, those skilled in the art, having the benefit of this disclosure, will appreciate numerous modifications and variations therefrom. It is intended that all such modifications and variations fall within the spirit and scope of the invention.

The foregoing embodiments and advantages are merely exemplary and are not to be constructed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A method for bookmarking content being transferred between devices in a network, the method comprising:
receiving a request for bookmarking content being transferred to at least one of a plurality of devices capable of performing playback of the content on which the bookmarking is requested;
obtaining state information from the at least one of a plurality of devices; and
creating a bookmark comprising the state information and source information of the state information;
wherein the source information of the state information obtained from a first device of the plurality of devices is persistent information and not exposed to the network;
wherein the source information of the state information obtained from the first device has the same structure as source information assigned to a second device of the plurality of devices other than the first device.

2. The method of claim 1, wherein the source information comprises:
a unique device identifier (UDN);
a service ID; and
a service type.

3. The method of claim 1, wherein the source information is internally obtained.

4. The method of claim 1, wherein the first device is a media renderer for rendering the content provided by the second device.

5. The method of claim 4, wherein the step of obtaining state information from the at least one of a plurality of devices comprises:
obtaining state information for playback management from the second device; and
obtaining state information for rendering control internally from the media renderer.

6. The method of claim 5, wherein the steps of obtaining state information for playback management from the second device and obtaining state information for rendering control internally from the media render comprise invoking an action for obtaining state variables.

7. The method of claim 5, wherein the source information of the state information obtained from the second device is obtained from a device and service descriptor provided from the second device when the second device is initially discovered on the network.

8. The method of claim 4, wherein the step of creating the bookmark comprises creating the bookmark in the second device by invoking an object creating action to the second device.

9. The method of claim 1, wherein the first device is a media server for providing content to the second device.

10. The method of claim 9, wherein the step of obtaining state information from the at least one of a plurality of devices comprises:
obtaining state information for internal playback management from the media server; and
obtaining state information for rendering control from the second device.

11. The method of claim 10, wherein the steps of obtaining state information for internal playback management from the media server and obtaining state information for rendering control from the second device comprise invoking an action for obtaining state variables.

12. The method of claim 10, wherein the source information of the state information obtained from the second device is obtained from a device and service descriptor provided from the second device when the second device is initially discovered on the network.

13. The method of claim 9, wherein the step of creating the bookmark comprises creating the bookmark internally in the media server.

14. A method for bookmarking content being transferred between devices in a network, the method comprising:
utilizing a transport service and a control service for transferring the content;
receiving a request for bookmarking the content being transferred;
obtaining state information of the transport service and the control service, wherein the state information of at least one of the transport service and the control service is obtained through an internal interface that is not subject to a communication protocol on the network; and
creating a bookmark comprising the state information and source information of the state information.

15. The method of claim 14, wherein the transport service is an AVTransport service (AVTS) and the control service is a Rendering Control Service (RCS).

16. The method of claim 14, wherein the source information of the state information obtained through the internal interface is persistent information and not exposed to the network, and has the same structure as source information assigned to a device exposed to the network.

17. The method of claim 14, wherein the transport service, the control service and a control application for controlling the transport service and the control service are integrated in a combo device.

18. The method of claim 14, wherein the control service and the control application for controlling the transport service and the control service are integrated in a combo device.

19. The method of claim 14, wherein the transport service and the control application for controlling the transport service and the control service are integrated in a combo device.

20. The method of claim 14, wherein the source information comprises:
a unique device identifier (UDN);
a service ID; and
a service type.

21. An apparatus for bookmarking content being transferred between devices in a network, the apparatus comprising:
means for receiving a request for bookmarking content being transferred to at least one of a plurality of devices capable of performing playback of the content on which the bookmarking is requested;
means for obtaining state information from the at least one of a plurality of devices; and
means for creating a bookmark comprising the state information and source information of the state information;
wherein the source information of the state information obtained from a first device of the plurality of devices is persistent information and not exposed to the network;
wherein the source information of the state information obtained from the first device has the same structure as source information assigned to a second device of the plurality of devices other than the first device.

22. The apparatus of claim 21, wherein the source information comprises:
a unique device identifier (UDN);
a service ID; and
a service type.

23. The apparatus of claim 21, wherein the source information is internally obtained.

24. The apparatus of claim 21, wherein the first device is a media renderer for rendering the content provided by the second device.

25. The apparatus of claim 24, wherein the means for obtaining state information from the at least one of a plurality of devices comprises:
means for obtaining state information for playback management from the second device; and
means for obtaining state information for rendering control internally from the media renderer.

26. The apparatus of claim 25, wherein the means for obtaining state information for playback management from the second device and obtaining state information for rendering control internally from the media render comprise invoking an action for obtaining state variables.

27. The apparatus of claim 25, wherein the source information of the state information obtained from the second device is obtained from a device and service descriptor provided from the second device when the second device is initially discovered on the network.

28. The apparatus of claim 24, wherein the means for creating the bookmark comprises creating the bookmark in the second device by invoking an object creating action to the second device.

29. The apparatus of claim 21, wherein the first device is a media server for providing content to the second device.

30. The apparatus of claim 29, wherein the means for obtaining state information from the at least one of a plurality of devices comprises:
means for obtaining state information for internal playback management from the media server; and
means for obtaining state information for rendering control from the second device.

31. The apparatus of claim 30, wherein the means for obtaining state information for internal playback management from the media server and obtaining state information for rendering control from the second device comprise invoking an action for obtaining state variables.

32. The apparatus of claim 30, wherein the source information of the state information obtained from the second device is obtained from a device and service descriptor provided from the second device when the second device is initially discovered on the network.

33. The apparatus of claim 29, wherein the means for creating the bookmark comprises creating the bookmark internally in the media server.

34. An apparatus for bookmarking content being transferred between devices in a network, the apparatus comprising:
means for utilizing a transport service and a control service for transferring the content;
means for receiving a request for bookmarking the content being transferred;
means for obtaining state information of the transport service and the control service, wherein the state information of at least one of the transport service and the control service is obtained through an internal interface that is not subject to a communication protocol on the network; and
means for creating a bookmark comprising the state information and source information of the state information.

35. The apparatus of claim 34, wherein the transport service is an AVTransport service (AVTS) and the control service is a Rendering Control Service (RCS).

36. The apparatus of claim 34, wherein the source information of the state information obtained through the internal interface is persistent information and not exposed to the network, and has the same structure as source information assigned to a device exposed to the network.

37. The apparatus of claim 34, wherein the transport service, the control service and a control application for controlling the transport service and the control service are integrated in a combo device.

38. The apparatus of claim 34, wherein the control service and the control application for controlling the transport service and the control service are integrated in a combo device.

39. The apparatus of claim 34, wherein the transport service and the control application for controlling the transport service and the control service are integrated in a combo device.

40. The apparatus of claim 34, wherein the source information comprises:
a unique device identifier (UDN);
a service ID; and
a service type.
